(19) United States
(12) Patent Application Publication
(10) Pub. No.: US 2025/0328322 A1
(43) Pub. Date: Oct. 23, 2025

(54) COMPUTING DEVICE, COMPUTING METHOD, AND RECORDING MEDIUM

(71) Applicant: NEC Corporation, Minato-ku, Tokyo (JP)

(72) Inventor: Kazuhisa ISHIZAKA, Tokyo (JP)

(73) Assignee: NEC Corporation, Minato-ku, Tokyo (JP)

(21) Appl. No.: 18/868,228

(22) PCT Filed: Jun. 2, 2022
(86) PCT No.: PCT/JP2022/022510

§ 371 Date: Nov. 22, 2024

(51) Int. Cl. G06F 8/41

(52) U.S. Cl. CPC G06F 8/41

(57) ABSTRACT

A computing device determines, for each part of a source program, whether the part is to be converted to an intermediate representation or is to be executed without conversion to the intermediate representation. The computing device generates the intermediate representation of the part of the source program that has been determined to be converted to the intermediate representation. The computing device determines whether data obtained as a result of executing the intermediate representation include data requiring conversion to a data representation format of the source program. If it is determined that there are corresponding data, the computing device generates the intermediate representation including an instruction to convert a data representation format of that data. The computing device instruct execution of the intermediate representation, by executing the part of the source program that has been determined not to be converted to the intermediate representation.

### TECHNICAL FIELD

The present invention relates to a computing device, a computing method, and a recording medium.

### BACKGROUND ART

There are cases where the source program is partially converted and executed, such as runtime compilation of a program.

For example, Non Patent Document 1 describes generating a graph, called an IR Graph, for a portion of a program, and then calling the program for which the portion corresponding to the IR Graph has been compiled to execute a sequence of operations.

### PRIOR ART DOCUMENTS

### Patent Documents

Non Patent Document 1: Alex Suhan, and six others, “LazyTensor: combining eager execution with domain-specific compilers”, arXiv: 2102.13267, 2021.

### SUMMARY OF THE INVENTION

### Problems to Be Solved by the Invention

If a source program is partially converted into an Intermediate Representation (IR) and executed, the burden of system development is expected to be relatively small by using existing libraries for both the execution of the source program and the execution of the converted IR. In this case, it is considered desirable to have as many parts of the source program as possible that can be converted to intermediate representations and executed.

An example object of this invention is to provide a computing device, a computing method, and a recording medium that can solve the above-mentioned problems.

### Means for Solving the Problem

According to the first example aspect of the invention, a computing device includes: an intermediate representationization determination means for determining, for each part of a source program, which is a program to be executed, whether the part is to be converted to an intermediate representation or is to be executed without conversion to the intermediate representation; an intermediate representation generating means for generating the intermediate representation of the part of the source program that has been determined to be converted to the intermediate representation, the intermediate representation generating means determining whether data obtained as a result of executing the intermediate representation include data requiring conversion to a data representation format of the source program, and if it is determined that there are corresponding data, generating the intermediate representation including an instruction to convert a data representation format of that data; a source program execution means for instructing execution of the intermediate representation, by executing the part of the source program that has been determined not to be converted to the intermediate representation; and an intermediate representation execution means for executing the intermediate representation of which execution has been instructed.

According to the second example aspect of the invention, a computing method is executed by a computer, and includes: determining, for each part of a source program, which is a program to be executed, whether the part is to be converted to an intermediate representation or is to be executed without conversion to the intermediate representation; generating the intermediate representation of the part of the source program that has been determined to be converted to the intermediate representation, determining whether data obtained as a result of executing the intermediate representation include data requiring conversion to a data representation format of the source program, and if it is determined that there are corresponding data, generating the intermediate representation including an instruction to convert a data representation format of that data; instructing execution of the intermediate representation, by executing the part of the source program that has been determined not to be converted to the intermediate representation; and executing the intermediate representation of which execution has been instructed.

According to the third example aspect of the invention, a recording medium records a program for causing a computer to execute: determining, for each part of a source program, which is a program to be executed, whether the part is to be converted to an intermediate representation or is to be executed without conversion to the intermediate representation; generating the intermediate representation of the part of the source program that has been determined to be converted to the intermediate representation, determining whether data obtained as a result of executing the intermediate representation include data requiring conversion to a data representation format of the source program, and if it is determined that there are corresponding data, generating the intermediate representation including an instruction to convert a data representation format of that data; instructing execution of the intermediate representation, by executing the part of the source program that has been determined not to be converted to the intermediate representation; and executing the intermediate representation of which execution has been instructed.

### Effect of Invention

According to the present invention, if a source program is partially converted into an intermediate representation and executed, existing libraries can be used for both execution of the source program and execution of the converted intermediate representation, and a relatively large portion of the source program can be converted into an intermediate representation and executed.

### BRIEF DESCRIPTION OF THE DRAWINGS

FIG. 1 is a diagram that shows an example of the configuration of the computing device according to the example embodiment.

FIG. 2 is a diagram that shows an example of intermediate representation parts generated by the intermediate representation generation portion.

FIG. 3 is a diagram that shows an example of the representation format of matrix data in the parent library according to the example embodiment.

FIG. 4 is a diagram that shows an example of the representation format of matrix data in a child library according to the example embodiment.

FIG. 5 is a diagram that shows an example of an intermediate representation including data conversion instructions generated by the data conversion instruction generation portion for intermediate according to the example embodiment.

FIG. 6 is a diagram that shows an example of an intermediate code including data conversion instructions generated by the data conversion instruction generation portion for intermediate according to the example embodiment.

FIG. 7 is a diagram that shows an example of a source program that includes the part converted to the intermediate representation and the part executed in the source program.

FIG. 8 is a diagram that shows an example of intermediate code including data conversion instructions generated by the data conversion instruction generation portion for intermediate according to the example embodiment.

FIG. 9 is a diagram that shows an example of intermediate code including data conversion instructions generated by the data conversion instruction generation portion for source according to the example embodiment.

FIG. 10 is a diagram that shows an example of data flow in the control portion according to the example embodiment.

FIG. 11 is a diagram that shows another example of the configuration of the computing device according to the example embodiment.

FIG. 12 is a diagram that shows an example of the processing steps in the calculation method according to the example embodiment.

FIG. 13 is a schematic block diagram of a computer according to at least one example embodiment.

### EXAMPLE EMBODIMENT

The following is a description of example embodiments of the present invention, but the following example embodiments do not limit the scope of the claimed invention. All of the combinations of features described in the example embodiments may not be essential to the solution of the invention.

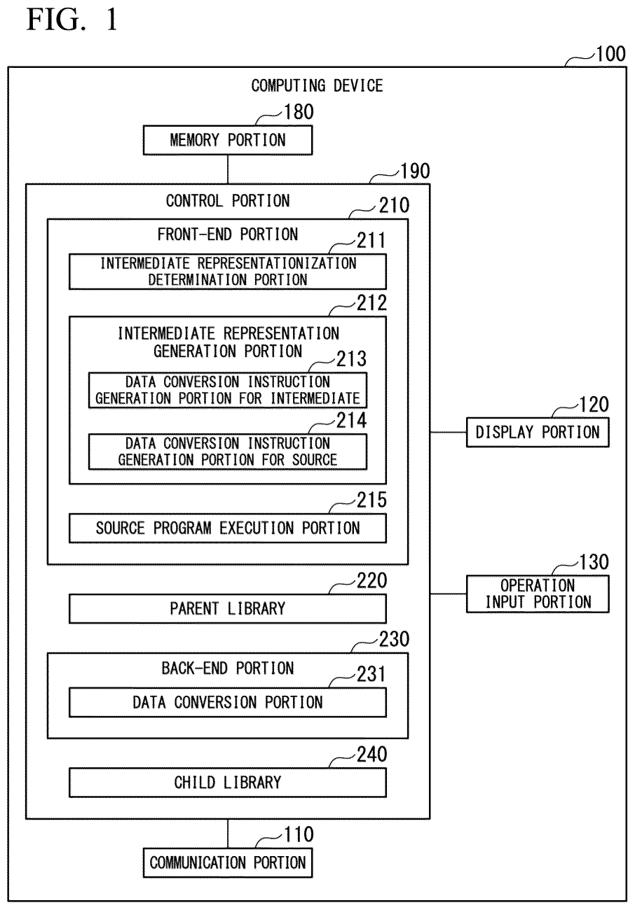

FIG. 1 is a diagram that shows an example of the configuration of the computing device according to the example embodiment. In the configuration shown in FIG. 1, a computing device 100 includes a communication portion 110, a display portion 120, an operation input portion 130, a memory portion 180, and a control portion 190. The control portion 190 has a front-end portion 210, a parent library 220, a back-end portion 230, and a child library 240. The front-end portion 210 includes an intermediate representationization determination portion 211, an intermediate representation generation portion 212, a data conversion instruction generation portion for intermediate 213, a data conversion instruction generation portion for source 214, and a source program execution portion 215. The back-end portion 230 is equipped with a data conversion portion 231.

The computing device 100 partially converts a source program, which is a program to be executed, such as a user program, into an intermediate representation and executes it. The computing device 100 may act as a runtime compiler (just-in-time compiler) to partially convert the source program into an intermediate representation for execution.

Converting a source program to an intermediate representation is also referred to as intermediate representationization or intermediate representation generation. Generally, a program is not deleted in a case where it is executed. For the computing device 100, it is conceivable to leave the part of the original source program that has been converted to the intermediate representation without deleting it. However, the computing device 100 may delete the portion of the original source program that has been converted to an intermediate representation.

The computing device 100 is composed of a computer, such as a personal computer (PC).

The communication portion 110 communicates with other devices. For example, the communication portion 110 may communicate with another computer, such as a user's terminal device, to receive the source program. However, the method by which the computing device 100 obtains the source program is not limited to a specific method.

The display portion 120 has a display screen, such as a liquid crystal panel or light emitting diode (LED) panel, for example, to acquire various images. For example, the display portion 120 displays data and other information according to the display instructions in the source program.

The operation input portion 130 includes input devices such as a keyboard and mouse, for example, and accepts user operations. For example, the operation input portion 130 may accept a user operation that indicates execution of the source program. The display portion 120 may display an editor screen for inputting and editing source programs, and the operation input portion 130 may accept user operations for programming source programs.

The memory portion 180 stores various data. For example, the source program obtained by the communication portion 110 or the operation input portion 130 may be stored by the memory portion 180. The memory portion 180 is configured using the storage device provided by the computing device 100.

The control portion 190 controls the various parts of the computing device 100 to perform various processes. In particular, the control portion 190 executes the source program. As described above for the computing device 100, the control portion 190 partially converts the source program into an intermediate representation and executes it.

The functions of the control portion 190 are performed, for example, by the central processing unit (CPU) provided by the computing device 100, which reads and executes a program from the storage portion 180.

The computing device 100 may include an accelerator such as a graphics processing unit (GPU) in addition to the CPU, so that the functions of the control portion 190 are performed using the accelerator as well as the CPU. For example, the control portion 190 may convert the part of the source program that can be executed on the GPU into an intermediate representation for the GPU and execute it on the GPU, while the other part of the source program may be executed on the CPU by executing the source program.

The computing device 100 executes both the source program and the intermediate representation using a library. To execute an intermediate representation here means to perform operations, etc., that are represented in the intermediate representation format.

In the configuration of FIG. 1, the parent library 220 corresponds to an example of a library used to execute source programs, while the child library 240 corresponds to an example of a library used to execute intermediate representations.

The programming language of the parent library and source program is not limited to any particular one. The programming language of the child library and intermediate representation is also not limited to any particular one.

For example, the programming language of the parent library and source program may be one that provides a relatively wide variety of operations, etc., to make it easier for users to program. The programming language of the child library and intermediate representation may have some advantageous features over the execution of the source program, such as faster execution, while offering fewer operations and the like. Furthermore, for example, the programming language of the child library and intermediate representation may be a domain specific language (DSL) specific to the device that executes the intermediate representation, such as a GPU.

The front-end portion 210 partially converts the source program into an intermediate representation, with the resulting intermediate representation being executed by the back-end portion 230. In addition, the front-end portion 210 executes the part of the source program that is not converted to an intermediate representation in the execution of the source program.

For each part of the source program, the intermediate representationization determination portion 211 decides whether or not to convert that part into an intermediate representation.

For example, for each part of the source program, the intermediate representationization determination portion 211 determines whether or not the part meets the predetermined criteria to be able to be changed to an intermediate representation. The intermediate representationization determination portion 211 decides to convert the part that is determined to meet the criteria into an intermediate representation. On the other hand, the intermediate representationization determination portion 211 decides to execute the parts that do not meet the criteria by running the source program without converting them into an intermediate representation.

The intermediate representationization determination portion 211 is an example of an intermediate representationization determination means.

The criterion for determining whether or not to convert a part of a source program to an intermediate representation is also referred to as the intermediate representationization criterion.

The following is an example of a case in which the intermediate representationization determination portion 211 determines, for each instruction or operation in a source program, whether or not to convert that instruction or operation to an intermediate representation. However, the unit in which the intermediate representationization determination portion 211 decides whether or not to convert a portion of the source program to an intermediate representation is not limited to a specific unit, such as per instruction or operation.

In the following, a distinction may not be made between instructions and operations.

The intermediate representationization criteria used by the intermediate representationization determination portion 211 may include the criterion of whether the instruction or operation that is the subject of the determination is supported by the library used to execute the intermediate representation.

For example, consider the case where the library used to execute the source program can use addition, subtraction, multiplication, and division operations, while the library used to execute the intermediate representation cannot use division. In this case, the intermediate representationization criteria may include the criterion of whether the subject of the determination is a division operation or not. The intermediate representationization determination portion 211 may decide, in accordance with this criterion, to perform the division operations included in the source program without converting them to intermediate representation.

The intermediate representationization criteria used by the intermediate representationization determination portion 211 may include the criterion of whether or not the data type used in the subject of the determination is supported by the library used to execute the intermediate representation.

For example, consider the case where the library used to execute the source program can define data of complex types, while the library used to execute the intermediate representation cannot handle data of complex types. In this case, the intermediate representation determination criteria may include the criterion of whether the subject of the determination handles complex number data. The intermediate representationization determination portion 211 may decide, according to this criterion, that the part of the source program that handles complex number data should be executed in the source program without converting it to an intermediate representation.

The intermediate representationization determination portion 211 decides to execute in the source program a given instruction that is scheduled to be executed in the source program among the instructions included in the source program. For example, the intermediate representationization determination portion 211 decides to execute a display instruction (e.g., a “print” statement) contained in the source program within the source program itself. The intermediate representationization criteria may include criteria such as executing in the source program itself a given instruction that is scheduled to be executed in the source program.

The intermediate representation generation portion 212 generates intermediate representations for parts of the source program that the intermediate representationization determination portion 211 has decided to convert into intermediate representations. The intermediate representation generation portion 212 is an example of an intermediate representation generation means.

The intermediate representations generated by the intermediate representation generation portion 212 are not executed immediately upon generation, but at the timing when the need to execute them arises. The execution of intermediate representations in this case is also referred to as delayed execution.

For example, consider a case where a source program contains a sequence (sequence of instructions) to calculate the value of variable f and an instruction “print (f)” to print the value of variable f. In this case, the intermediate representation generation portion 212 generates an intermediate representation of the sequence that computes the value of the variable f, but that intermediate representation is not executed at a timing when the intermediate representation is generated. Then, at the timing when the instruction to display the value of variable f is executed in the execution of the source program, the back-end portion 230 executes an intermediate representation of the sequence that calculates the value of the variable f, using the child library 240.

The process of determining the value of a variable or an operation is referred to as evaluating that variable or operation. The intermediate representation generation portion 212 may generate an intermediate representation in the form of a representation indicating the reference relationship of the operation so that the intermediate representation can be selected to calculate the value to be evaluated.

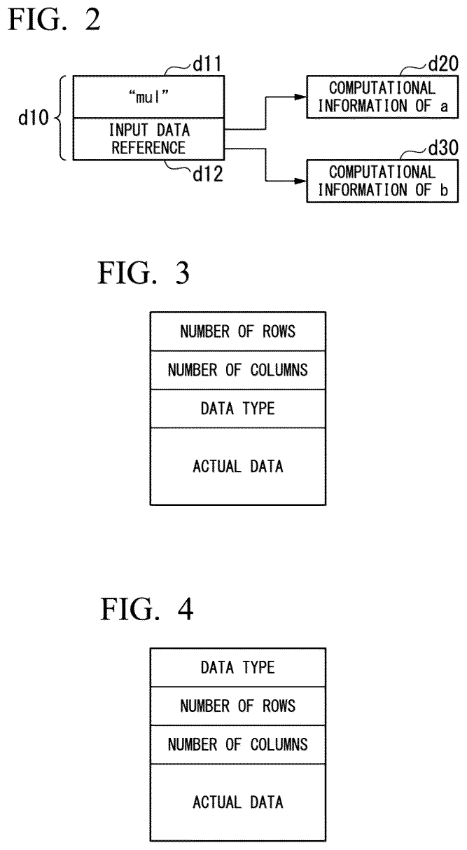

FIG. 2 is a diagram that shows an example of the components of an intermediate representation generated by the intermediate representation generation portion 212. The intermediate representation components illustrated in FIG. 2 are also referred to as computing information.

FIG. 2 shows an example of the computing information generated by the intermediate representation generation portion 212 for the operation “c=mat_mul(a, b)” in the source program. “mat_mul(a, b)” is a matrix operation that multiplies matrix a by matrix b, and with respect to this operation “mat_mul”, the operation “mul” shall correspond in the intermediate representation.

Information d11 is information indicating the instruction code that represents the type of instruction. In the example in FIG. 2, the operation name “mul” is shown as the instruction code.

Information d12 indicates the input data reference, which is information indicating the reference to the input data given to the instruction. FIG. 2 shows an example in a case where both input data “a” and “b” are calculated by computation, and links to the computational information for “a” and “b” are shown as input data references.

The combination of the instruction code and input data reference corresponds to an example of computational information. In the example in FIG. 2, information d10, which is a combination of information d11 and information d12, is an example of “c” computational information.

As shown in FIG. 2, where links are created from the computational information of “c” to the computational information of “a” and the computational information of “b,” the information combining the computational information by links corresponds to an example of intermediate representation. Intermediate representation can also be expressed as a sequence (instruction sequence). An intermediate representation expressed in a sequence is also referred to as an intermediate code or intermediate program.

Based on the example in FIG. 2, the intermediate representation generation portion 212 can generate intermediate code that calculates “c” by first calculating “a” and “b”, and then multiplying “a” and “b”, as the intermediate code for calculating “c”. The instruction to calculate “c” by multiplying “a” and “b” is expressed, for example, as “% c=mul(% a, % b)”. The “% a” corresponds to “a” in the source program. The “% b” corresponds to “b” in the source program. The “% c” corresponds to “c” in the source program.

The data conversion instruction generation portion for intermediate 213 determines whether any of the data referenced by the part of the source program that the intermediate representationization determination portion 211 has decided to convert to an intermediate representation requires conversion to the data representation format in the intermediate representation.

Here, there may be cases where the data representation format differs between the parent library 220 and the child library 240, such as in a case where both the parent library 220 and the child library 240 use existing libraries.

FIG. 3 is a diagram that shows an example of the representation format of matrix data in the parent library 220. In the example in FIG. 3, the matrix data is organized in the following order from the top of the figure: number of rows, number of columns, data type, and actual data.

FIG. 4 is a diagram that shows an example of the representation format of matrix data in the child library 240. In the example in FIG. 4, the matrix data is organized in the following order from the top of the figure: data type, number of rows, number of columns, and actual data.

Comparing the example in FIG. 3 with that in FIG. 4, in FIG. 3, the number of rows and number columns are indicated followed by the data type, whereas in FIG. 4, the data type is indicated first, then the number of rows and number of columns.

Thus, if the data representation format differs between the parent library 220 and the child library 240, the data obtained from the execution of the source program may not work correctly if applied directly to the intermediate representation. Therefore, the data conversion instruction generation portion for intermediate 213 generates a data conversion instruction to convert the data representation format and adds the instruction in the intermediate representation.

The data conversion instruction generation portion for intermediate 213 determines whether any of the data referenced in the execution of an intermediate representation requires conversion to the data representation format in the intermediate representation (data representation format in the child library 240). If it is determined that there is applicable data, the data conversion instruction generation portion for intermediate 213 generates a conversion instruction to change the data representation format of that data and adds it in the intermediate representation. Specifically, the data conversion instruction generation portion for intermediate 213 generates a data conversion instruction to convert from the data representation format in the parent library 220 to the data representation format in the child library 240 and adds it in the intermediate representation.

For example, if the execution of the source program yields matrix data in the data representation format of FIG. 3, the data conversion instruction generation portion for intermediate 213 generates a data conversion instruction that converts that data into matrix data in the data representation format of FIG. 4, and adds it in the intermediate representation.

Thereby, even if the source program contains data in a data representation format different from the data representation format in the child library 240, this is expected to allow the computing device 100 to execute the portion of the program contained in that data in the intermediate representation.

The data conversion instruction generation portion for intermediate 213 makes such a determination, creates a data conversion instruction, and inserts the instruction into the intermediate representation at any timing from the time of conversion from the source program part to the intermediate representation by the intermediate representation generation portion 212 up to but before the execution of the “evaluation” by the source program execution portion 215. The timing of the execution of “evaluation” by the source program execution portion 215 is when the results of the execution of intermediate representations are required.

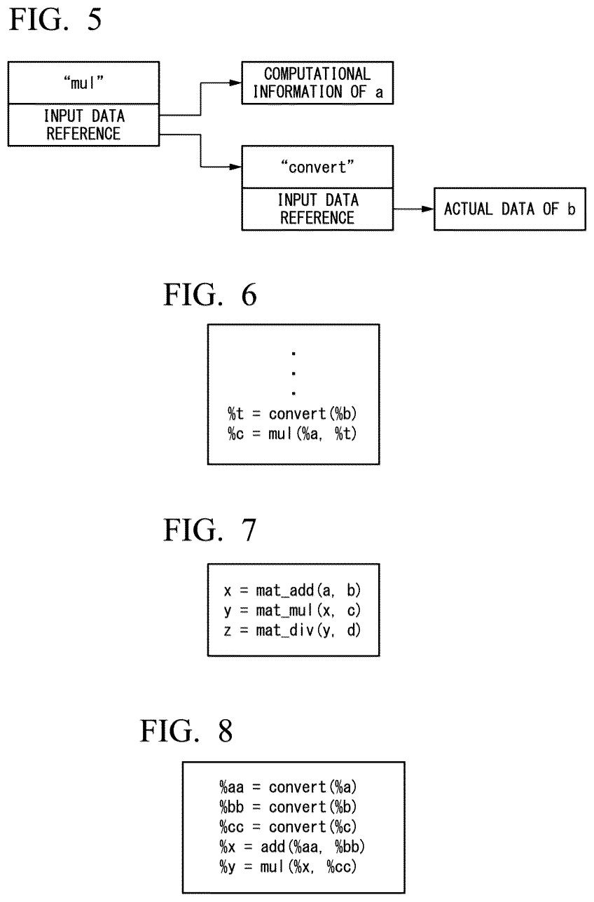

FIG. 5 is a diagram that shows an example of an intermediate representation including a data conversion instruction generated by the data conversion instruction generation portion for intermediate 213.

FIG. 5 shows an example of an intermediate representation generated by the intermediate representation generation portion 212 for the operation “c=mat_mul(a, b)” in the source program. As in the example in FIG. 2, in the example in FIG. 5, “mat_mul(a, b)” is a matrix operation that multiplies matrix a by matrix b, and with respect to this operation “mat_mul”, the operation “mul” shall correspond in the intermediate representation. As in the example in FIG. 2, in the example in FIG. 5, the input data “a” is assumed to be calculated by an operation. On the other hand, unlike the example in FIG. 2, in the example in FIG. 5, the input data “b” is assumed to be real data shown in the data representation format in the parent library 220.

In the example in FIG. 5, the data conversion instruction generation portion for intermediate 213 generates a data conversion instruction by the operation “convert” and includes it in the intermediate representation. In the example in FIG. 5, the operation “convert” takes the input of the real data of “b” and converts it to data in the data representation format in the child library 240.

FIG. 6 is a diagram that shows an example of an intermediate code including a data conversion instruction generated by the data conversion instruction generation portion for intermediate 213. In FIG. 6, the intermediate representation shown in FIG. 5 is presented in the form of a sequence (instruction sequence).

In the example in FIG. 6, “% a” corresponds to “a” in the source program. “% b” corresponds to “b” in the source program. “% t” indicates the result of the “convert” execution. In the intermediate code shown in FIG. 6, after the calculation of “a”, the actual data of “b” is converted by “convert”, and “c” is calculated by multiplying the calculated “a” with the data obtained by data conversion of “b” (“% t”).

If conversion of the data representation format of the data obtained as a result of execution of the intermediate representation is required, the data conversion instruction generation portion for source 214 generates a data conversion instruction for conversion of the data representation format and adds it in the intermediate representation.

In the examples in FIGS. 3 and 4, if the execution of the intermediate representation yields matrix data in the data representation format of FIG. 4, this data cannot be used directly in the execution of the source program. Therefore, the data conversion instruction generation portion for source 214 generates a data conversion instruction that converts the matrix data in the data representation format of FIG. 4 into the matrix data in the data representation format of FIG. 3, and adds it in the intermediate representation.

It is expected that the matrix data in the data representation format of FIG. 4, which is obtained in the execution of the intermediate representation, will be converted to the matrix data in the data representation format of FIG. 3, and the converted data can then be used in the execution of the source program.

The data conversion instruction generation portion for source 214 determines whether any of the data obtained as a result of the execution of intermediate representation requires conversion to the data representation format in the source program (data representation format in the parent library 220). If it is determined that there is applicable data, the data conversion instruction generation portion for source 214 generates a conversion instruction for the data representation format of that data and adds it in the intermediate representation. Specifically, the data conversion instruction generation portion for source 214 generates a data conversion instruction to convert from the data representation format in the child library 240 to the data representation format in the parent library 220 and adds it in the intermediate representation.

The data conversion instruction generation portion for source 214 makes such a determination, creates a data conversion instruction, and inserts the instruction into the intermediate representation at any timing from the time of conversion from the source program part to the intermediate representation by the intermediate representation generation portion 212 up to but before the execution of the “evaluation” by the source program execution portion 215. The timing of the execution of “evaluation” by the source program execution portion 215 is when the results of the execution of intermediate representations are required.

FIG. 7 is a diagram that shows an example of a source program that includes parts converted to intermediate representations and a part executed in the source program.

In the example in FIG. 7, “mat_add” indicates matrix addition. “mat_mul” indicates matrix multiplication. “mat_div” indicates matrix division. It is also assumed that “a”, “b”, “c”, and “d” are all actual data in the data representation format in the parent library 220.

Here, it is assumed that matrix division is defined in the parent library 220, whereas matrix division is not defined in the child library 240. The intermediate representationization determination portion 211 decides to execute “x=mat_add(a, b)” and “y=mat_mul(x, c)” after conversion to intermediate representations, and decides to execute “z=mat_div(y, d)” in the source program (without conversion to an intermediate representation).

FIG. 8 is a diagram that shows an example of an intermediate code including a data conversion instruction generated by the data conversion instruction generation portion for intermediate 213. FIG. 8 shows an example of intermediate code to execute “x=mat_add(a, b)” and “y=mat_mul(x, c)” in the source program shown in FIG. 7.

As mentioned above, “convert” is an operation indicating a data conversion instruction generated by the data conversion instruction generation portion for intermediate 213. “add” corresponds to “mat_add” in the source program. “mul” corresponds to “mat_mul” in the source program.

“% a” corresponds to “a” in the source program. “% b” corresponds to “b” in the source program. “% c” corresponds to “c” in the source program. “% x” corresponds to “x” in the source program. “% y” corresponds to “y” in the source program. “% aa” indicates the execution result of “convert( % a)”. “% bb” indicates the result of “convert( % b)” execution. “% cc” indicates the result of “convert( % c)” execution.

For example, the intermediate representation generation portion 212 may generate the intermediate code shown in FIG. 8 or an intermediate representation corresponding to this intermediate code in a format that uses computational information by the time when the intermediate representationization determination portion 211 decides to execute “z=mat_div(y, d)” in the source program.

The intermediate code shown in FIG. 8 includes a data conversion instruction that converts data in the data representation format in the parent library 220 to data in the data representation format in the child library 240, and the back-end portion 230 can execute this intermediate code.

However, the matrix data resulting from the execution of the intermediate code shown in FIG. 8 is presented in the data representation format in the child library 240, which is different from the data representation format in the parent library 220. Therefore, the result of the execution of the intermediate code shown in FIG. 8 cannot be used directly to execute “z=mat_div(y, d)” in the source program.

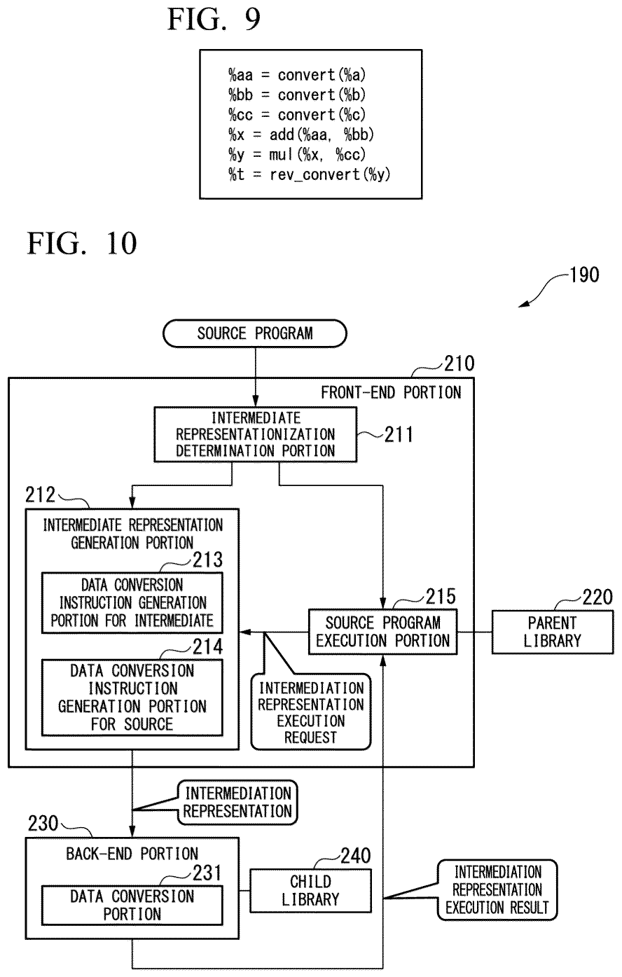

FIG. 9 is a diagram that shows an example of an intermediate code including a data conversion instruction generated by the data conversion instruction generation portion for source 214. FIG. 9 shows an example of intermediate code in which the data conversion instruction generated by the data conversion instruction generation portion for source 214 has been added to the intermediate code shown in FIG. 9.

In the example in FIG. 9, the data conversion instruction generation portion for source 214 generates a data conversion instruction by the operation “rev_convert” and adds it in the intermediate representation. In the example in FIG. 9, the operation “rev_convert” converts the matrix data in the data representation format in the child library 240 resulting from the execution of the intermediate representation to the data representation format in the parent library 220.

This allows the results of the execution of the intermediate representation to be obtained in a format that can be used to execute the source program.

For example, the data conversion instruction generation portion for source 214 may generate the data conversion instruction shown in FIG. 9 and adds it in the intermediate representation at a timing from the decision by the intermediate representationization determination portion 211 to execute “z=mat_div(y, d)” in the source program to before the execution of “evaluation” by the source program execution portion 215.

The source program execution portion 215 executes the source program in the source program (without converting it to an intermediate representation). In a case where the source program execution portion 215 executes the source program in the source program without conversion to an intermediate representation, it is also called fallback.

The source program execution portion 215 corresponds to an example of a source program execution means.

The parent library 220 is a library that corresponds to the programming language of the source program. The source program execution portion 215 performs fallback using the parent library 220. For example, the computing device 100 accepts source programs that use operations provided by the parent library 220. The source program execution portion 215 then executes the source program by calling the operations in the parent library 220.

Also, it is assumed that instructions that involve evaluation, such as the “print” instruction, are not converted into intermediate representations, but are specified to be executed in the source program by the source program execution portion 215.

The back-end portion 230 executes the intermediate representation. The intermediate representation generation portion 212 may output the intermediate representation in the form of intermediate code to the back-end portion 230, which then executes the intermediate code.

The data conversion portion 231 of the back-end portion 230 executes the data conversion instruction generated by the data conversion instruction generation portion for intermediate 213 and the data conversion instruction generated by the data conversion instruction generation portion for source 214, among the intermediate representations generated by the intermediate representation generation portion 212. These data conversion instructions pertain to the portions of the intermediate representation generated by the intermediate representation generation portion 212 that are not supported by the child library 240.

The portion of the intermediate representation generated by the intermediate representation generation portion 212, other than the data conversion instruction executed by the data conversion portion 231, is executed by the back-end portion 230. In other words, the portion of the intermediate representation generated by the intermediate representation generation portion 212 that is supported by the child library 240 is executed by the back-end portion 230.

The back-end portion 230 is an example of an intermediate representation execution means.

The child library 240 is a library that corresponds to the programming language of the intermediate representation. The portion of the intermediate representation generated by the intermediate representation generation portion 212, other than the data conversion instruction executed by the data conversion portion 231, is executed by the back-end portion 230 using the child library 240. For example, the back-end portion 230 performs the operations shown in the intermediate representation by calling the operations in the child library 240.

The combination of the front-end portion 210 and the back-end portion 230 is also referred to as an intermediate representation library. The intermediate representation library provides the execution environment for the operations provided by the parent library 220. The intermediate representation library executes a part of the source program by converting it into an intermediate representation, which allows the source program to run faster compared to using the parent library 220, for example.

The intermediate representation library may further have the function to optimize intermediate representations. For example, if the intermediate representation generation portion 212 generates intermediate representations specific to a particular domain, such as matrix operations, the intermediate representation library may optimize the intermediate representations based on knowledge specific to that domain.

FIG. 10 is a diagram that shows an example of data flow in the control portion 190.

In the example in FIG. 10, the intermediate representationization determination portion 211 acquires the source program and determines, for each part of the acquired source program, whether to convert it to an intermediate representation or not to convert it to an intermediate representation and execute it in the source program.

For example, the intermediate representationization determination portion 211 analyzes the source program in the order described in the source program to extract parts of the source program such as instructions or operations. Then, for each extracted part of the source program, the intermediate representationization determination portion 211 decides whether or not to convert the part into an intermediate representation.

The intermediate representationization determination portion 211 outputs the part of the source program it has decided to convert into an intermediate representation to the intermediate representation generation portion 212. In addition, the intermediate representationization determination portion 211 outputs to the source program execution portion 215 the part of the source program it has decided not to convert to an intermediate representation and execute in the source program.

The intermediate representation generation portion 212 converts the part of the source program obtained from the intermediate representationization determination portion 211 into an intermediate representation. For example, the intermediate representation generation portion 212 generates the computational information as illustrated in FIG. 2 and FIG. 5 on the basis of the source program obtained from the intermediate representationization determination portion 211.

As mentioned above, the intermediate representations generated by the intermediate representation generation portion 212 are not immediately executed, but are executed at a timing when a need arises in the execution of the source program.

As mentioned above, in a case where both the parent library 220 and the child library 240 use existing libraries, the data representation format in the parent library 220 and the data representation format in the child library 240 may differ. Therefore, the data conversion instruction generation portion for intermediate 213 and the data conversion instruction generation portion for source 214 each generate data conversion instructions and add them in the intermediate representation.

The source program execution portion 215 executes the part of the source program to be obtained from the intermediate representationization determination portion 211.

As described above, the source program execution portion 215 executes the source program using the parent library 220, such as calling operations, etc. provided by the parent library 220.

In addition, the source program execution portion 215 executes instructions that involve evaluation, such as “print” instructions, in the source program. In a case where the execution of an instruction that involves evaluation requires the execution of an intermediate representation, the source program execution portion 215 presents the data for which values are needed to the intermediate representation generation portion 212 and requests execution of the intermediate representation.

In a case where the intermediate representation generation portion 212, upon receiving a request to execute an intermediate representation from the source program execution portion 215, selects an intermediate representation in order to calculate the requested data value. The intermediate representation generation portion 212 then outputs the selected intermediate representation in the form of intermediate code, as illustrated in FIG. 6, to the back-end portion 230 for execution.

The back-end portion 230 executes the intermediate representation obtained from the intermediate representation generation portion 212. Specifically, the data conversion portion 231 executes the data conversion instruction generated by the data conversion instruction generation portion for intermediate 213 and the data conversion instruction generated by the data conversion instruction generation portion for source 214 among the intermediate representations. The portion of the intermediate representation other than the data conversion instruction executed by the data conversion portion 231 is executed by the back-end portion 230 using the child library 240.

It is conceivable that neither the data conversion instruction generated by the data conversion instruction generation portion for intermediate 213, nor the data conversion instruction generated by the data conversion instruction generation portion for source 214 are included in the child library 240. Therefore, the back-end portion 230 is equipped with a data conversion portion 231 as a functional portion that executes these data conversion instructions.

The back-end portion 230 outputs the data resulting from the execution of intermediate representations to the source program execution portion 215. If it is necessary to convert the data representation format of data obtained as a result of the execution of the intermediate result as described above, the data conversion portion 231 converts the data representation format according to the data conversion instruction contained in the intermediate representation. The back-end portion 230 then outputs the data after conversion by the data conversion portion 231 to the source program execution portion 215.

As described above, the intermediate representationization determination portion 211, for each part of a source program, which is a program to be executed, determines whether the part is to be converted to an intermediate representation or is to be executed without conversion to an intermediate representation. The intermediate representation generation portion 212 generates an intermediate representation of each part of the source program that has been determined to be converted to an intermediate representation. The intermediate representation generation portion 212 determines whether data obtained as a result of executing the intermediate representation include data requiring conversion to the data representation format of the source program, and if it is determined that there are corresponding data, generates the intermediate representation including an instruction to convert the data representation format of the data. The source program execution portion 215 indicates execution of the intermediate representation by executing the parts of the source program that have been determined not to be converted to the intermediate representation. The back-end portion 230 executes the intermediate representation of which execution has been indicated.

According to the computing device 100, in a case where a source program is partially converted into an intermediate representation and executed, existing libraries can be used for both execution of the source program and execution of the converted intermediate representation, and a relatively large portion of the source program can be converted into an intermediate representation and executed.

In particular, even if the data representation format of the data obtained as a result of execution of the intermediate representation cannot be directly used in the execution of the source program, the intermediate representation generation portion 212, by the data conversion instruction included in the intermediate representation, can perform conversion to a data representation format that can be used in the source program. According to the computing device 100, in this respect, relatively large portions of the source program can be converted to intermediate representations and executed, and the results of the execution can be used in the execution of the source program.

The intermediate representationization determination portion 211 determines that the part of the source program that is determined to contain data of a data type not supported by the child library 240, which is the library used for execution of the intermediate representation, is to be executed without conversion to an intermediate representation.

According to the computing device 100, in a case where a source program is partially converted into an intermediate representation and executed, existing libraries can be used for both execution of the source program and execution of the converted intermediate representation, and source programs that include data types not supported by the library used for execution of the intermediate representation can also be executed.

The intermediate representation generation portion 212 determines whether data referenced by the part of the source program determined to be converted to an intermediate representation include data requiring conversion to the data representation format of the intermediate representation, and if it is determined that there are corresponding data, generates an intermediate representation including an instruction to convert the data representation format of the data.

According to the computing device 100, in a case where a source program is partially converted into an intermediate representation and executed, existing libraries can be used for both execution of the source program and execution of the converted intermediate representation, and a relatively large portion of the source program can be converted into an intermediate representation and executed.

In particular, even if a portion of the source program references data in a data representation format that cannot be used in the execution of the intermediate representation as is, the intermediate representation generation portion 212, by the data conversion instruction included in the intermediate representation, can convert the data representation format of that data to a data representation format that can be used in the execution of the intermediate representation. According to the computing device 100, in this respect, relatively large portions of the source program can be converted to intermediate representations and executed, and the results of the execution can be used in the execution of the source program.

The intermediate representationization determination portion 211 determines that the portion of the source program that is determined to include operations not supported by the child library 240, which is the library used for execution of the intermediate representation, is to be executed without conversion to an intermediate representation.

According to the computing device 100, in a case where a source program is partially converted into an intermediate representation and executed, existing libraries can be used for both execution of the source program and execution of the converted intermediate representation, and source programs that include operations not supported by the library used for execution of the intermediate representation can also be executed.

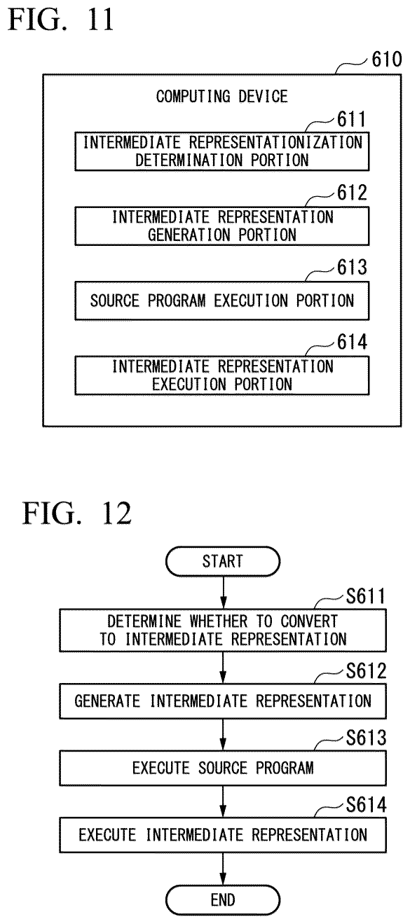

FIG. 11 is a diagram that shows another example of the configuration of the computing device according to the example embodiment. In the configuration shown in FIG. 11, a computing device 610 includes an intermediate representationization determination portion 611, an intermediate representation generation portion 612, a source program execution portion 613, and an intermediate representation execution portion 614.

In such a configuration, the intermediate representationization determination portion 611, for each part of a source program, which is a program to be executed, determines whether the part is to be converted to an intermediate representation or is to be executed without conversion to an intermediate representation. The intermediate representation generation portion 612 generates an intermediate representation of each portion of the source program that has been decided to be converted to an intermediate representation. The intermediate representation generation portion 612 determines whether data obtained as a result of executing the intermediate representation include data requiring conversion to the data representation format of the source program, and if it is determined that there are corresponding data, generates an intermediate representation including an instruction to convert the data representation format of the data. The source program execution portion 613 instructs execution of the intermediate representation by executing the parts of the source program that have been determined not to be converted into an intermediate representation. The intermediate representation execution portion 614 executes the intermediate representation of which execution has been instructed.

The intermediate representationization determination portion 611 is an example of an intermediate representationization determination means. The intermediate representation generation portion 612 is an example of an intermediate representation generation means. The source program execution portion 613 corresponds to an example of a source program execution means. The intermediate representation execution portion 614 is an example of an intermediate representation execution means.

According to the computing device 610, in a case where a source program is partially converted into an intermediate representation and executed, existing libraries can be used for both execution of the source program and execution of the converted intermediate representation, and a relatively large portion of the source program can be converted into an intermediate representation and executed.

In particular, even if the data representation format of the data obtained as a result of execution of the intermediate representation cannot be directly used in the execution of the source program, the intermediate representation generation portion 612, by the data conversion instruction included in the intermediate representation, can perform conversion to a data representation format that can be used in execution of the source program. According to the computing device 610, in this respect, relatively large portions of the source program can be converted to intermediate representations and executed, and the results of the execution can be used in the execution of the source program.

FIG. 12 is a diagram that shows an example of the processing steps in the calculation method according to the example embodiment. The computing method shown in FIG. 12 includes determining whether to convert to an intermediate representation (Step S611), generating an intermediate representation (Step S612), executing a source program (Step S613), and executing an intermediate representation (Step S614).

In determining whether to convert to an intermediate representation (Step S611), for each part of the source program that is the program to be executed, the computer determines whether the part is to be converted to an intermediate representation or is to be executed without conversion.

In generating an intermediate representation (Step S612), the computer generates an intermediate representation of the portion of the source program that has been determined to be converted to an intermediate representation, determines whether data obtained as a result of executing the intermediate representation include data requiring conversion to the data representation format of the source program, and if it is determined that there are corresponding data, generates an intermediate representation including an instruction to convert the data representation format of that data.

In executing the source program (Step S613), the computer indicates execution of the intermediate representation, by executing the parts of the source program that have been determined not to be converted to the intermediate representation.

In executing an intermediate representation (Step S614), the computer executes the intermediate representation of which execution has been indicated.

According to the computing method shown in FIG. 12, in a case where a source program is partially converted to an intermediate representation and executed, existing libraries can be used for both execution of the source program and execution of the converted intermediate representation, and a relatively large portion of the source program can be converted to an intermediate representation and executed.

In particular, even if the data representation format of the data obtained as a result of execution of the intermediate representation cannot be directly used in the execution of the source program, by the data conversion instruction included in the intermediate representation, it is possible to perform conversion to a data representation format that can be used in execution of the source program. According to the computing method shown in FIG. 12, in this respect, relatively large portions of the source program can be converted to intermediate representations and executed, and the results of the execution can be used in the execution of the source program.

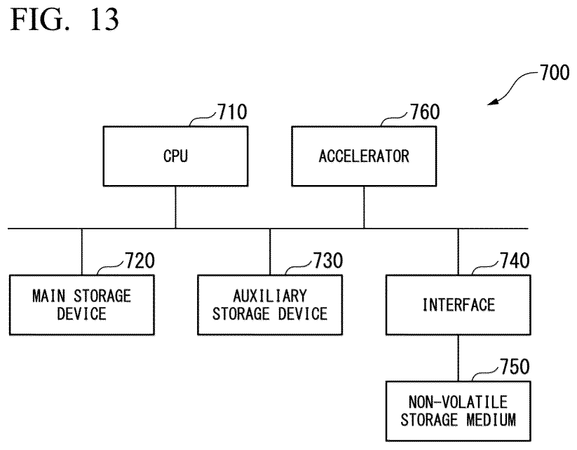

FIG. 13 is a schematic block diagram of a computer according to at least one example embodiment.

In the configuration shown in FIG. 13, a computer 700 includes a CPU 710, a main storage device 720, an auxiliary storage device 730, an interface 740, a non-volatile storage medium 750, and an accelerator 760.

Any one or more of the above computing device 100 and computing device 610, or parts thereof, may be implemented in the computer 700. In that case, the operations of each of the above-mentioned processing portions are stored in the auxiliary storage device 730 in the form of a program. The CPU 710 and the accelerator 760 read the program from the auxiliary storage device 730, extract it to main storage device 720, and execute the above processing according to the program. The CPU 710 also secures a storage area in the main storage device 720 corresponding to each of the above-mentioned storage portions according to the program. Communication between each device and other devices is performed by the interface 740, which has a communication function and communicates according to the control of the CPU 710.

If the computing device 100 is implemented in the computer 700, the operation of the control portion 190 and the various portions thereof is stored in the auxiliary storage device 730 in the form of a program. The CPU 710 and the accelerator 760 read the program from the auxiliary storage device 730, extract it to main storage device 720, and execute the above processing according to the program.

The CPU 710 also secures a storage area in the main storage device 720 for the storage portion 180 according to the program. Communication between the computing device 100 and other devices is performed by the interface 740, which has a communication function and operates according to the control of the CPU 710. Interaction between the computing device 100 and the user is performed by the interface 740, which is equipped with a display and input devices and displays various images and accepts user operations according to the control of the CPU 710.

If the computing device 610 is implemented in the computer 700, the operations of the intermediate representationization determination portion 611, the intermediate representation generation portion 612, the source program execution portion 613, and the intermediate representation execution portion 614 are stored in the auxiliary storage device 730 in program form. The CPU 710 and the accelerator 760 read the program from the auxiliary storage device 730, extract it to main storage device 720, and execute the above processing according to the program.

The CPU 710 also secures a storage area in the main memory 720 for processing by the computing device 610 according to the program. Communication between the computing device 610 and other devices is performed by the interface 740, which has a communication function and operates according to the control of the CPU 710. Interaction between the computing device 610 and the user is performed by the interface 740, which is equipped with a display and input devices and displays various images and accepts user operations according to the control of the CPU 710.

Any one or more of the above programs may be recorded on a non-volatile recording medium 750. In this case, the interface 740 may read the program from the non-volatile recording medium 750. The CPU 710 and the accelerator 760 may then directly execute the program read by the interface 740 or save it once in the main storage device 720 or auxiliary storage device 730 before execution.

A program for executing all or part of the processes performed by the computing device 100 and the computing device 610 may be recorded on a computer-readable recording medium, and the program recorded on this recording medium may be loaded into a computer system to perform the processing of each portion. The term “computer system” here shall include an operating system (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The aforementioned program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs and the like to the extent that they do not depart from the gist of this invention.

Some or all of the above example embodiments may also be described as, but not limited to, the following supplementary notes.

### Supplementary Note 1

A computing device comprising:
an intermediate representationization determination means for determining, for each part of a source program, which is a program to be executed, whether the part is to be converted to an intermediate representation or is to be executed without conversion to the intermediate representation;
an intermediate representation generating means for generating the intermediate representation of the part of the source program that has been determined to be converted to the intermediate representation, the intermediate representation generating means determining whether data obtained as a result of executing the intermediate representation include data requiring conversion to a data representation format of the source program, and if it is determined that there are corresponding data, generating the intermediate representation including an instruction to convert a data representation format of that data;
a source program execution means for instructing execution of the intermediate representation, by executing the part of the source program that has been determined not to be converted to the intermediate representation; and
an intermediate representation execution means for executing the intermediate representation of which execution has been instructed.

### Supplementary Note 2

The computing device according to supplementary note 1, wherein the intermediate representationization determination means determines that a part of the source program that has been determined to include data of a data type not supported by a library used to execute the intermediate representation is to be executed without conversion to the intermediate representation.

### Supplementary Note 3

The computing device according to supplementary note 1 or supplementary note 2, wherein the intermediate representation generating means determines whether data referenced by the part of the source program determined to be converted to the intermediate representation include data requiring conversion to a data representation format of the intermediate representation, and if it is determined that there are corresponding data, generates the intermediate representation including an instruction to convert a data representation format of that data.

### Supplementary Note 4

The computing device according to any one of supplementary notes 1 to 3, wherein the intermediate representationization determination means determines that a part of the source program that has been determined to include an operation not supported by a library used to execute the intermediate representation is to be executed without conversion to the intermediate representation.

### Supplementary Note 5

A computing method executed by a computer, comprising:
determining, for each part of a source program, which is a program to be executed, whether the part is to be converted to an intermediate representation or is to be executed without conversion to the intermediate representation;
generating the intermediate representation of the part of the source program that has been determined to be converted to the intermediate representation, determining whether data obtained as a result of executing the intermediate representation include data requiring conversion to a data representation format of the source program, and if it is determined that there are corresponding data, generating the intermediate representation including an instruction to convert a data representation format of that data;
instructing execution of the intermediate representation, by executing the part of the source program that has been determined not to be converted to the intermediate representation; and
executing the intermediate representation of which execution has been instructed.

### Supplementary Note 6

A recording medium that records a program for causing a computer to execute:
determining, for each part of a source program, which is a program to be executed, whether the part is to be converted to an intermediate representation or is to be executed without conversion to the intermediate representation;
generating the intermediate representation of the part of the source program that has been determined to be converted to the intermediate representation, determining whether data obtained as a result of executing the intermediate representation include data requiring conversion to a data representation format of the source program, and if it is determined that there are corresponding data, generating the intermediate representation including an instruction to convert a data representation format of that data;
instructing execution of the intermediate representation, by executing the part of the source program that has been determined not to be converted to the intermediate representation; and
executing the intermediate representation of which execution has been instructed.

### INDUSTRIAL APPLICABILITY

The present invention may be applied to a computing device, a computer method, and a recording medium.

### REFERENCE SIGNS LIST

100, 610 Computing device
110 Communication portion
120 Display portion
130 Operation input portion
180 Memory portion
190 Control portion
210 Front-end portion
211, 611 Intermediate representationization determination portion
212, 612 Intermediate representation generation portion
213 Data conversion instruction generation portion for intermediate
214 Data conversion instruction generation portion for source
215, 613 Source program execution portion
220 Parent library
230 Back-end portion
231 Data conversion portion
240 Child library
614 Intermediate representation execution portion

What is claimed is:

1. A computing device comprising:
a memory configured to store instructions; and
a processor configured to execute the instructions to:
determine, for each part of a source program, which is a program to be executed, whether the part is to be converted to an intermediate representation or is to be executed without conversion to the intermediate representation;
generate the intermediate representation of the part of the source program that has been determined to be converted to the intermediate representation, wherein generating comprises determining whether data obtained as a result of executing the intermediate representation include data requiring conversion to a data representation format of the source program, and if it is determined that the data include the data requiring conversion, generating the intermediate representation including an instruction to convert a data representation format of the data requiring conversion;
instruct execution of the intermediate representation, by executing the part of the source program that has been determined not to be converted to the intermediate representation; and
execute the intermediate representation of which execution has been instructed.

2. The computing device according to claim 1, wherein the processor is configured to execute the instructions to determine that a part of the source program that has been determined to include data of a data type not supported by a library used to execute the intermediate representation is to be executed without conversion to the intermediate representation.

3. The computing device according to claim 1, wherein the processor is configured to execute the instructions to determine whether data referenced by the part of the source program determined to be converted to the intermediate representation include data requiring conversion to a data representation format of the intermediate representation, and if it is determined that the part of the source program include the data requiring conversion, generate the intermediate representation including an instruction to convert a data representation format of the that data requiring conversion.

4. The computing device according to claim 1, wherein the processor is configured to execute the instructions to determine that a part of the source program that has been determined to include an operation not supported by a library used to execute the intermediate representation is to be executed without conversion to the intermediate representation.

5. A computing method executed by a computer, comprising:
determining, for each part of a source program, which is a program to be executed, whether the part is to be converted to an intermediate representation or is to be executed without conversion to the intermediate representation;
generating the intermediate representation of the part of the source program that has been determined to be converted to the intermediate representation, wherein generating comprises determining whether data obtained as a result of executing the intermediate representation include data requiring conversion to a data representation format of the source program, and if it is determined that the data include the data requiring conversion, generating the intermediate representation including an instruction to convert the data representation format of the data requiring conversion;
instructing execution of the intermediate representation, by executing the part of the source program that has been determined not to be converted to the intermediate representation; and
executing the intermediate representation of which execution has been instructed.

6. A non-transitory recording medium that records a program for causing a computer to execute:
determining, for each part of a source program, which is a program to be executed, whether the part is to be converted to an intermediate representation or is to be executed without conversion to the intermediate representation;
generating the intermediate representation of the part of the source program that has been determined to be converted to the intermediate representation, wherein generating comprises determining whether data obtained as a result of executing the intermediate representation include data requiring conversion to a data representation format of the source program, and if it is determined that the data include the data requiring conversion, generating the intermediate representation including an instruction to convert the data representation format of the data requiring conversion;
instructing execution of the intermediate representation, by executing the part of the source program that has been determined not to be converted to the intermediate representation; and
executing the intermediate representation of which execution has been instructed.
